(19) United States
(12) Patent Application Publication
(10) Pub. No.: US 2025/0041701 A1
(43) Pub. Date: Feb. 6, 2025

(54) DISPLAY UNIT FOR EXERCISE MACHINES

(71) Applicant: TECHNOGYM S.p.A., Cesena (IT)

(72) Inventors: Ivan LISI, Cesena (IT); Camilo ESCOBEDO FORERO, Cesena (IT); Mario FEDRIGA, Cesena (IT); Claudia PATELLA, Cesena (IT); Luca RASCHI, Cesena (IT)

(21) Appl. No.: 18/791,625

(22) Filed: Aug. 1, 2024

(30) Foreign Application Priority Data
Aug. 3, 2023 (IT) 102023000016680

(51) Int. Cl. A63B 71/06; A63B 24/00; G06F 3/044

(52) U.S. Cl. CPC A63B 71/0619; A63B 24/0075; A63B 24/0087; G06F 3/0448; A63B 2071/0675

(57) ABSTRACT

Display unit for an exercise machine, comprising:
a controller, a first display, a second display;
a control panel comprising:
   a screen provided with a groove for guiding the navigation of a user within a navigable menu and a plurality of graphic keys each associated to a user-selectable function or command;
   a capacitive keypad including a first electrode associated to the groove and a plurality of additional electrodes each operatively associated to a key and connected to the controller by means of conductive tracks.

When a user touches the groove or one key, the control unit causes visualization on the first display of the menu, or implementation of a function associated with the display unit, or transmission to the machine of a command associated to the touched key. The control unit causes visualization of a selected training session on the first display, and of operating parameters of the machine or parameters results at the end of a training session on the second display.

The present disclosure relates to a display unit for exercise machines.

The use of devices or display units associated to exercise machines, such as treadmills, bikes, etc., is widely used and known in the art.

Said units are configured in such a way that the user is able to select the desired type of training session, for example uphill running, flat course, tempo run, distance running, etc., to set up and/or modify during execution one or more of the parameters of the selected session, such as duration, difficulty level, rhythm/speed, and to visualize the approximate values of the ongoing or finished performance.

Said units known in the art, while making it possible to adequately perform the services for which they were conceived, however present certain aspects which could be improved particularly regarding production simplicity and costs, ease of use, functional integrity in the presence of contaminating agents which can cause malfunction, such as drops of sweat, typical and inevitable during the performance of training sessions.

Hence, there is desire and room for an improved display unit.

The presence disclosure provides a display unit for an exercise machine, comprising at least:
at least one controller;
a first display for displaying at least one navigable menu comprising training sessions selectable and parameterizable by a user;
at least a second display suitable for displaying at least user-settable parameter values indicative of the operation of the exercise machine during the execution of a user-selected training session or parameters relating to the results at the end of the execution of the selected training session;
a control panel which includes:
a screen on which there is provided a groove for guiding the navigation of the user within said navigable menu, and on which are graphically represented a plurality of keys each of which associable with a user-selectable function or command;
a capacitive keypad including a first electrode operably associated with said groove, and a plurality of additional electrodes operably associable each with a key of said plurality of keys, said first electrode and said plurality of additional electrodes being connected each to said at least one controller by corresponding electrically conductive tracks;

and wherein said at least one controller is configured to receive in input a signal selectively indicative of the change in capacity caused by the action of the user on said groove or on one of said keys and to emit a corresponding command signal causing:
displaying on the first display said navigable menu of training sessions when the user has acted on the groove;
implementing a function associated with the display unit itself or imparting to the exercise machine a command associated with the key on which the user has acted, said at least one controller causing the first display to show on the first display the training session selected and on the second display at least one or more operating parameters of the exercise machine currently selected or one or more parameters relating to the results at the end of the execution of the training session selected.

Particular embodiments are object of the respective dependent claims whose contents are intended as an integral part of the present description.

Further characteristics and advantages of the disclosure will become more apparent from the following detailed description of exemplary and non-limiting embodiments, and with reference to the attached drawings in which:

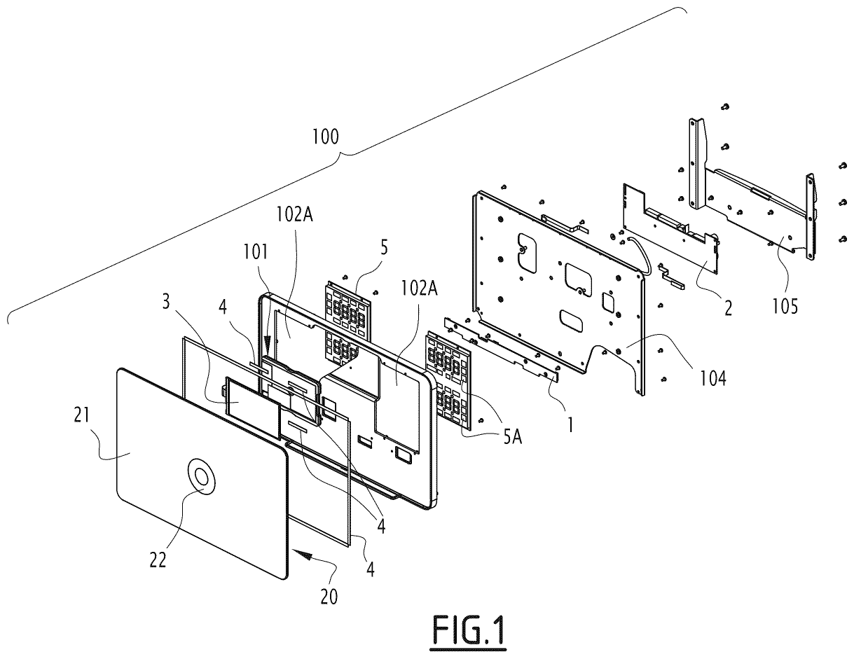

FIG. 1 is an exploded view which schematically illustrates a display unit for exercise machines according to the present disclosure;

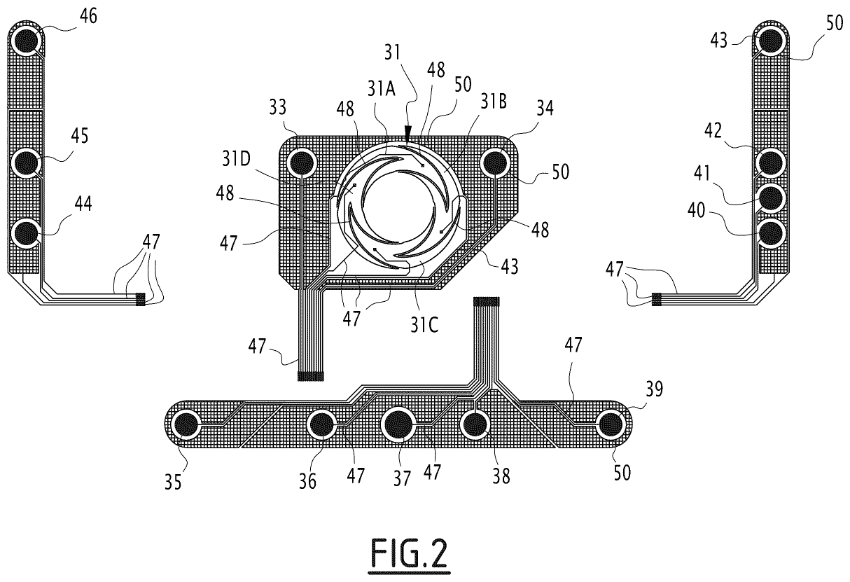

FIG. 2 is a frontal view which schematically illustrates a portion of a capacitive keypad used in the display unit for exercise machines according to the disclosure;

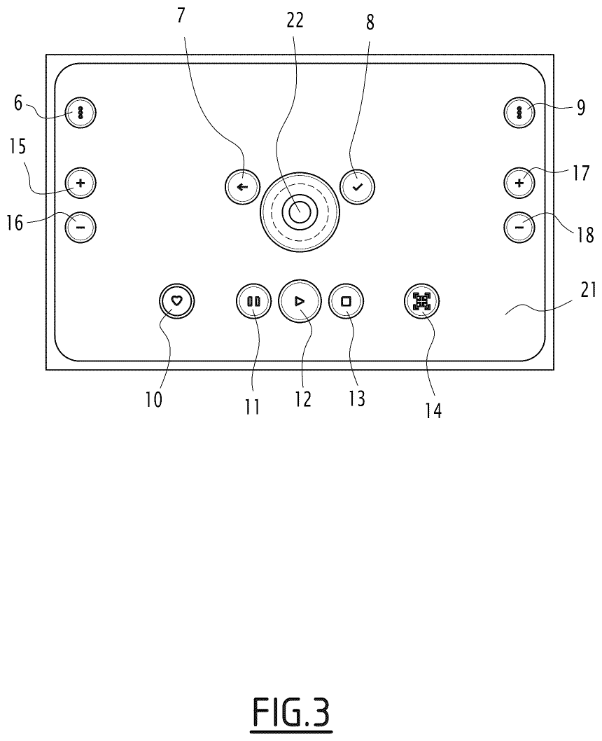

FIG. 3 is a frontal view illustrating a plurality of keys represented graphically on the front screen of the display unit, in an embodiment according to the disclosure;

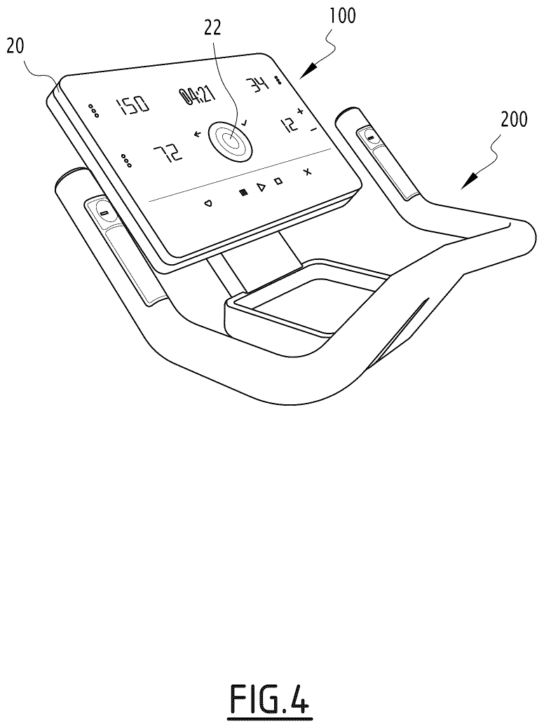

FIG. 4 illustrates a display unit for exercise machines mounted on the handlebars of a bike.

It should be noted that in the following detailed description the components illustrated in the figures are not necessarily to scale and certain characteristics of the description may be shown in a rather schematic form.

Furthermore, when the term “configured” or “shaped”, or a similar term is used in the present context with reference to any component whatsoever as a whole, or any part whatsoever of a component, said term is intended as comprising correspondingly the structure and/or the configuration and/or the shape and/or the positioning of the component or part to which it refers.

In particular, when said terms refer to hardware or software electronic means they are intended as including circuits or parts of electronic circuits, as well as software/firmware, such as algorithms, routines and programs in general, in execution and/or resident in any storage medium whatsoever.

FIG. 1 schematically illustrates an exemplary embodiment of a display unit for exercise machines according to the present disclosure, indicated with reference number 100, while FIG. 4 illustrates the display unit 100 mounted on the handlebars of a bike 200.

Clearly, the bike represents only an example of a possible exercise machine to which the display unit can be associated, and the display unit 100 according to the disclosure can be used with other exercise machines, for example treadmills, etc.

As illustrated, the display unit 100 comprises:
at least one electronic control unit (or controller) 1;
a first display 3, in particular a liquid-crystal display, for displaying at least one navigable menu comprising training sessions selectable and parameterizable by a user;
at least a second display 5 suitable for displaying at least user-settable parameter values indicative of the operation of the exercise machine 200 during the execution of a user-selected training session or parameters relating to the results (or the user's performance data) at the end of the execution of the selected training session.

In the exemplary embodiment illustrated in FIG. 1, the display unit 100 comprises a further display 5A, hereinafter third display 5A, the two displays 5 and 5A being for example substantially structurally and functionally similar to each other.

The second display 5 and, when used the third display 5A, are for example LED displays.

The display unit 100 further comprises a control panel 20 which includes a capacitive keypad 30 and a screen or cover lens 21 (hereinafter simply screen 21), for example at least partially transparent, which is made for example of screen-printed glass and which is placed over the front of the capacitive keypad 30.

Usefully, on the at least partially transparent screen 21, there is provided, e.g. by means of milling, a groove 22 for guiding the navigation of the user within the navigable menu of training sessions.

Furthermore, on the screen 21 a plurality of keys 6, 7, 8, 9, 10, 11, 12, 13, 14, 15, 16, 17, 18 are graphically represented (hereinafter for descriptive simplicity indicated as “keys” or “graphic keys”) each of which associable to a user-selectable function or command.

In particular, as illustrated in FIG. 2, the capacitive keypad 30 includes a first electrode 31, operatively associated to the groove 22, and a plurality of additional electrodes 33, 34, 35, 36, 37, 38, 39, 40, 41, 42, 43, 44, 45 operatively associable each to a key of said plurality of graphic keys 6, 7, 8, 9, 10, 11, 12, 13, 14, 15, 16, 17, 18 which are graphically represented on the screen 21.

The first electrode 31 and the plurality of additional electrodes 33, 34, 35, 36, 37, 38, 39, 40, 41, 42, 43, 44, 45 are each connected to the at least one controller 1 by means of corresponding electrically conductive tracks 47.

The number of graphic keys represented on the screen 21 can be appropriately varied depending on the exercise machine to which the display unit is to be associated and on the functions the exercise machine is to provide.

In particular, the display unit 100 conveniently comprises a capacitive keypad 30 common to all types of exercise machines so that said display unit can be used in accordance with the applications, changing the set of graphic keys represented on the screen 21.

Usefully, in an exemplary embodiment, the at least one controller 1 is configured to selectively inhibit operation of at least one electrode of said plurality of additional electrodes 33, 34, 35, 36, 37, 38, 39, 40, 41, 42, 43, 44, 45, 46, in particular when one of the keys is not graphically represented on the screen 21.

In practice, if for a specific exercise machine the use of a command or specific function is not foreseen, then the corresponding graphic key is not represented on the screen 21 and operation of the corresponding electrode on the capacitive keypad 30 can be inhibited via software, e.g. by means of the at least one controller 1.

In this way, if a user mistakenly touches an area of the screen 21 where no graphic key is represented, below said area there is in any case an electrode of the capacitive keypad 30 relative to the function of the non-represented key, but said error does not involve any reply from the display unit 100 by virtue of the inhibition procedure.

The functions/commands associated to the graphic keys can be functions relative to functions of the display unit 100 itself or associated to it, and the commands can be relative to actions to be transmitted to the exercise machine 200 itself.

Furthermore, one or more of the graphic keys, preferably all of them, are graphically represented by means of icons/symbols which symbolize the function/command associated to it.

For example, in an embodiment, and as illustrated for example in FIG. 3, a first sub-group of keys 7 and 8 are visualized on the two sides of the groove 22 and are associated the first (key 7) to a function of return/cancellation with respect to a selection visualized on the first display 3 or possibly selected by the user, and the second (key 8) to confirmation of a selection identified by the groove 22 and visualized on the first display 3.

A second sub-group of keys, i.e. keys 10, 11, 12, 13 e 14, are visualized for example in a lower central area of the screen 21, and comprise a key 10 for managing connections with heart rate belts, a key 11 to transmit to the exercise machine 200 a pause command, a key 12 to transmit to the exercise machine 200 a start or re-start training session command, a key 13 to transmit to the exercise machine 200 a definitive stop command or to carry out a final cooling-down step and a key 14 for identification of the user on the exercise machine by means of an identification code or the connection with a personal device of the user, such as a smart-watch or smart-phone.

A third group of keys, i.e. keys 6, 15 and 16, 9 and 17 and 18, are visualized for example on the two sides of the screen 21. For example, the keys 6 and 9 are associated, by means of the respective electrodes of the underlying capacitive keypad 30, to the controller for managing the data to be visualized on one or both displays 5 and 5A, while the keys 15 and 16 and 17 and 18 are associated to the visualization of training parameters which can be modified by a user acting on keys 15 or 17 (increase) and 16 or 19 (decrease) and whose values are visualized on the display 5 or the displays 5 and 5A during the training session.

In a possible embodiment, the capacitive keypad 30 can comprise a first dielectric layer, a conductive layer and a support layer. Between the various layers there may be protective layers and adhesive layers to guarantee functionality of the components.

The electrically conductive material used in the capacitive keypad 30 can be of different types, for example copper, indium-tin oxide, silver, etc.

In the display unit 100 according to the disclosure, the at least controller 1 is configured to receive in input, from the capacitive keypad 30, a signal selectively indicative of the change in electric capacitance caused by the action of the user on the groove 22 or on one of the graphic keys 6, 7, 8, 9, 10, 11, 12, 13, 14, 15, 16, 17, 18 and to emit a corresponding command signal.

In particular, if a user has acted on the groove 22, the at least one controller 1 is configured to emit a corresponding command signal suitable to at least visualize on the display 3 the navigable menu of training sessions selected and parameterized by the user.

In particular, during the action by the user on the groove 22, the electronic controller 1 continually processes the signal indicative of the change in capacitance caused by the action of the user, and enables gradual visualization of the navigable menu pages (which may also comprise various navigable sub-menus).

In a possible embodiment, the groove 22 and the associated first electrode 31 can be configured so as to implement also, by means of the controller 1, a function/command for the exercise machine.

If, however, the user has acted on one of the graphic keys, the at least one electronic control unit 1 is configured to emit a corresponding command signal suitable to implement a function/command associated to the graphic key on which the user has acted.

In correspondence with the actions of the user, the at least one controller 1 is further configured to cause, during execution of the training session or when it finishes, visualization, on the first display 3, of the selected training session and, on the display 5 or on the second and third displays 5 and 5A correspondingly, of at least one or more operating parameters currently selected of the exercise machine or parameters relating to the user results at the end of the execution of the training session selected.

In practice, some graphic keys have the function of changing visualization, while others have the function of regulating the operating parameters of the machine. The latter also cause a change in visualization in the sense that the value of the operating parameter visualized is consequently updated.

For example, if the speed on a treadmill is increased by acting on the corresponding graphic key, the current speed value visualized is refreshed.

Conveniently, according to a possible embodiment which is both simple and effective, the display unit 100 comprises one or more layers or pieces 4 of bi-adhesive material configured to attach the display 3 and each LED display 5, 5A to the control panel 20.

In particular, the first and second displays 3 and 5 and, where used, also the third display 5A, are fixed, e.g. glued directly or indirectly to the rear side of the control panel, for example by means of one or more pieces of bi-adhesive material 4.

For example, as illustrated in FIG. 1, the first display 3 is inserted into a support 101, e.g. pocket-shaped, which is fixed to the control panel 20 by means of at least one piece of bi-adhesive so as to be as near as possible to the panel 20 itself.

In their turn, the second display 5 and when used the third display 5A, are connected to a support 102 which is fixed to the control panel 20A.

In the embodiment illustrated in FIG. 1, the second and third displays 5, 5A, are placed substantially symmetrically to each other on the sides of the first display 3 and are arranged in correspondence with two openings 102A provided for on the support 102.

Clearly, assembly of the various parts, and in particular fixing of each display 3, 5 and 5A can be carried out in a different manner, such as for example by mechanical fixing with screws, air bonding or optical bonding.

As illustrated in the embodiment in FIG. 1, the display unit 100 further comprises a rear metallic wall 104 and a support 105, for example also metallic, which, once assembled with the control panel 20 and all the components placed in between, substantially form the rear part of the display unit 100 itself.

In a possible embodiment, the capacitive keypad 30 is a self-capacitive keypad where for each graphic key 6, 7, 8, 9, 10, 11, 12, 13, 14, 15, 16, 17, 18 and for said groove 22, there is provided only one corresponding electrode.

In this case, while the display unit 100 is being used, for example the user's finger represents a second electrode when he “presses” a corresponding key, a variation in the capacitance of the system is generated and suitably processed by the at least one controller 1. More in detail, the electrode of the single button can be made with a single conductive element or with a plurality of conductive elements so as to obtain several signals and increase the reliability of detection of the contact with the user's finger.

This solution is particularly simple for efficient operation in the presence of drops of sweat.

Alternatively, the capacitive keypad 30 is a mutually capacitive keypad where for each graphic key 6, 7, 8, 9, 10, 11, 12, 13, 14, 15, 16, 17, 18 and for said groove 22 there is provided a corresponding pair of electrodes.

In this case, when the user's finger “presses” a key, the electric field between the two electrodes associated to said key varies, so changing the capacitive coupling.

In a further embodiment, the capacitive keypad is partly self capacitive and partly mutual capacitive.

In a possible embodiment, the display unit 100, and in particular its capacitive keypad 30, comprises a protective grid 50 arranged around the first electrode 31 and each electrode of the plurality of additional electrodes 33, 34, 35, 36, 37, 38, 39, 40, 41, 42, 43, 44, 45, 46.

Said grid 50 is, for example, made of strips of intersecting conductive material to form a grid and placed on a layer of dielectric material.

The grid 50 carries out a protective function limiting the emission of electromagnetic signals for the user, as well as the one of “security”, determining the effective activation of a key, as opposed to “anomalous” situations.

In particular, if the user's finger is not exactly on the key but also partly on the grid, the at least one controller 1 is configured so as to detect this anomalous situation and not to consider the partial touch of the key as an effective selection of said key.

Another advantage associated to the grid is the detection of other “abnormal” situations, such as those caused by sweat; in fact, a drop of sweat would be able to vary the electric capacitance similarly to the touch of a finger.

In particular, in order to avoid a drop of sweat activating a key, the electronic controller 1 is configured so as to interpret a signal indicative of capacitance change caused by the user acting on the groove 22 or on one of the graphic keys only if the capacitance variation takes place at a speed greater than a determined threshold.

In fact, if for example a drop of sweat falls on the grid 50 (or partly on the grid and partly on a key) and slides towards the area near a key, the algorithm implemented in the controller 1 is configured so that said capacitance change is not interpreted as a real touch of the key since the drop of sweat varies the capacitance gradually and not suddenly as would happen instead in the case of an effective touch of a finger.

Furthermore, the change in capacitance is proportional to the contact area; in the case where an object with conductivity characteristics (for example the metallic surface of a mobile phone) is placed on the screen 21, the fact that it covers several keys enables the controller to exclude that what is taking place is due to the touch of a finger on a key.

In a possible embodiment, as illustrated in FIGS. 1 and 2, the groove 22 and said first electrode 31 are ring-shaped and can be activated by the user by means of swiping a finger along the groove 22 or, alternatively, by pressing on a plurality of predetermined positions angularly spaced apart from each other along said groove.

In particular, according a possible embodiment illustrated in FIG. 2, the first electrode 31 is formed by a plurality of angular sectors, preferably four angular sectors 31A, 31B, 31C, 31D, which are made of electrically conductive material and are electrically separated two-by-two from each other by corresponding sections of dielectric material 48.

In this case, as illustrated in FIG. 2, each of the angular sectors 31A, 31B, 31C, 31D of electrically conductive material is connected to the first electronic controller 1 by means of a corresponding electrically conductive track 47.

As illustrated in FIG. 2, each section of dielectric material 48 interrupts the electric continuity between an angular sector and the adjacent one and can be shaped, for example, like the curved tip of an arrow or an eagle's beak.

According to this embodiment, the at least one controller 1 is configured so as to receive in input said signal selectively indicative of the change in capacitance caused by the action of the user along the groove 22 corresponding to at least one angular sector of said plurality of angular sectors 31A, 31B, 31C, 31D and to convert the detected change in capacitance into a digital signal indicative of the corresponding angular position along the groove 22 where the user acted.

In this way, depending on the sector swiped by the user on the display 3, corresponding parts of the navigable menu are visualized on the first display 3, for example, one or more icons visualized in sequence and each relative to a selectable training session.

In a possible embodiment of the display 100 according to the disclosure, the at least one electronic control unit 1 is composed of a single electronic control unit or controller which is suitably configured to carry out the various functions described.

In a further possible embodiment, and as illustrated in FIG. 1, the at least one electronic control unit 1 comprises a first electronic controller 1 (or first controller) and a second electronic controller 2 (or second controller).

The first electronic controller 1 is connected to the capacitive keypad 30 and to the second electronic controller 2 and is dedicated mainly to controlling the capacitive keypad 30 and to processing the signals that it emits.

In particular, the first electronic controller 1 is configured so as to receive in input from the capacitive keypad each signal selectively indicative of the change in capacitance caused by the user's action on the groove 22 or on one of the visualized graphic keys, and to emit a corresponding signal indicative of the action carried out by the user.

For example, said electronic controller 1 comprises a suitable printed circuit board associated to a microcontroller which converts the analogue signals received from the capacitive keypad 30 into digital signals to supply them in input to the second controller 2.

The second electronic controller 2 is for example dedicated to actually controlling the exercise machine 200 and can also comprise a printed circuit board and an associated processor which carries out one or more software modules for the management logic of the functions relative to the various keys and to the groove 22.

In practice, the second controller 2 is configured so as to receive in input from said first electronic controller 1 said corresponding digital signal and emit said corresponding command signal.

For example, if that which is processed by the first electronic controller 1 is identified as an effective press on a key by the user, then this triggers the event connected to the pressed key and a message is sent to the second electronic controller 2 where the relative operational flows are implemented for the emission of the command signal and any possible corresponding visualizations on the first display 3 and/or the second display 5 and/or the third display 5A.

Consequently, it is the second controller 2 that decides which action triggers that event on the display unit 100 or on the exercise machine and therefore what should be visualized on the first display 3 and/or on the display(s) 5, 5A, and/or if the exercise machine must for example start up, go into stand-by or stop.

In practice, when the user places himself on the exercise machine where the display unit 100 is installed and wants to carry out a training session, he starts by acting on the groove 22, for example swiping a finger along said groove 22 (or touching one of the predefined angular positions), so modifying the visualization on the display 3 and visualizing in sequence the possible training sessions available.

For example, the user may select, from the navigable menu on the display 3 which presents various icons each relative to a different session, a session with a time or alternatively a length objective and then confirm the choice with the key on the right (key 8) or go back by pressing the key on the left (key 7) if he chose the wrong session or changed his mind.

Once the desired training session has been selected, the user, acting on the groove 22, can modify one or more of its parameters; for example, if a time session has been selected, the length of time of the training session can be set to the value desired, and then confirmed by pressing the key 8 once more.

Furthermore, by acting on the various keys, the user can select one or more parameters that he wishes to visualize/modify.

The action on the graphic keys or on the groove 22 can be suitably accompanied by respective acoustic sounds or by tactile feedback implemented for example by the single electronic controller 1 or by the second electronic controller 2, if used.

Once the training session has been selected with the relative parameters, relating both to the selected session and to the operation of the exercise machine 200, the user selects the “play” button 12 and the exercise machine 200 starts up.

During said selections, the choices that are made, for example the selected session and/or the pre-set time, are graphically visualized on the first display 3, while the parameters set for the exercise machine are visualized on the second display 5 or correspondingly on both the second and third displays 5, 5A.

During the training session, the user can modify the exercise machine 200 settings, for example increasing or decreasing the value of a pre-set parameter.

For example, when the display unit 100 is associated to a treadmill, by acting on keys 15 and 16 the parameter “belt speed” can be increased or decreased, while by acting on keys 17 and 18 the parameter “belt inclination” can be increased or decreased.

Practically it has been established how the display unit 100 according to the disclosure reaches its intended scope in that it has a simple structure that can be produced at a relatively low cost, can be easily and intuitively operated by the user and where the negative effects of contaminating agents, especially drops of sweat, are mitigated.

Naturally, without prejudice to the scope of the disclosure, many variations and implementation details thereof may be applied to the above-described exemplary and non-limiting embodiments, without departing from the scope of protection of the disclosure as defined in the accompanying claims. For example, the screen 21 could be made of another material, the displays could use visualization modes and technologies different to those described above, etc.

1. Display unit for an exercise machine, comprising at least:
at least one controller;
a first display for displaying at least one navigable menu comprising training sessions selectable and parameterizable by a user;
at least a second display suitable for displaying at least user-settable parameter values indicative of the operation of the exercise machine during the execution of a user-selected training session or parameters relating to the results at the end of the execution of the selected training session;
a control panel which includes:
a screen on which there is provided a groove for guiding the navigation of the user within said navigable menu, and on which are graphically represented a plurality of keys, each of which associable with a user-selectable function or command;
a capacitive keypad including a first electrode operably associated with said groove, and a plurality of additional electrodes operably associable each with a key of said plurality of keys, said first electrode and said plurality of additional electrodes being connected each to said at least one controller by corresponding electrically conductive tracks;
and wherein said at least one controller is configured to receive in input a signal selectively indicative of the change in capacity caused by the action of the user on said groove or on one of said keys and to emit a corresponding command signal causing:
displaying on the first display said navigable menu of training sessions when the user has acted on the groove;
implementing a function associated with the display unit itself or imparting to the exercise machine a command associated with the key on which the user has acted, said at least one controller causing the first display to show on the first display the training session selected and on the second display at least one or more operating parameters of the exercise machine currently selected or one or more parameters relating to the results at the end of the execution of the training session selected.

2. The display unit according to claim 1, wherein said at least one controller is configured to selectively inhibit operation of at least one electrode of said plurality of additional electrodes.

3. The display unit according to claim 1, wherein said capacitive keypad is a self-capacitive keypad wherein for each key of said plurality of keys and for said groove there is provided only one corresponding electrode.

4. The display unit according to claim 1, wherein said capacitive keypad is a mutually capacitive keypad wherein for each graphic key and for said groove there is provided a corresponding pair of electrodes.

5. The display unit according to claim 1, comprising a protective grid arranged around the first electrode and each electrode of said plurality of further electrodes.

6. The display unit according to claim 1, wherein said groove and said first electrode have an annular shape and are configured to be actuatable by the user by swiping along said groove or by pressing on a plurality of predetermined positions angularly spaced apart from each other along said groove.

7. The display unit according to claim 6, wherein said first electrode comprises a plurality of angular sectors of electrically conductive material which are electrically separated two-by-two from each other by corresponding sections of dielectric material, each of the angular sectors of electrically conductive material being connected to said first electronic controller by a corresponding electrically conductive track.

8. The display unit according to claim 7, wherein said first electrode comprises four angular sectors of electrically conductive material which are electrically separated two by two from each other by four corresponding sections of dielectric material.

9. The display unit according to claim 7, wherein the at least one controller is configured to receive in input said signal selectively indicative of the change in capacitance caused by the action of the user along the groove at at least one angular sector of said plurality of angular sectors and to convert the detected change in capacitance into a digital signal indicative of the corresponding angular position along the groove where the user acted.

10. The display unit according to claim 1, wherein said at least one controller comprises:
a first controller which is configured to receive in input from the capacitive keypad said signal selectively indicative of the change in capacitance caused by the action of the user on the groove or on one of the graphic keys, and to output a corresponding digital signal indicative of the action performed by the user;
a second controller that is configured to receive in input from the first electronic controller said corresponding digital signal and emit said corresponding command signal.

11. Display unit according to claim 1, comprising at least one layer or piece of bioadhesive material configured to attach at least one of said first display and second display to the control panel.
